(19) United States
(12) Patent Application Publication
(10) Pub. No.: US 2006/0217065 A1
(43) Pub. Date: Sep. 28, 2006

(54) Radio frequency remote control apparatus and methodology

(75) Inventors: Michael Spilo, Greenwich, CT (US); Shmil Gan, Kiriat Ata (IL)

Correspondence Address: DARBY & DARBY P.C., P. O. BOX 5257, NEW YORK, NY, 10150-5257, US

(73) Assignee: Skipjam Corp., Greenwich, CT (US)

(21) Appl. No.: 11/087,715

(22) Filed: Mar. 23, 2005

(51) Int. Cl. H04B 7/00; H04B 1/06

(52) U.S. Cl. 455/41.2; 455/352

(57) ABSTRACT

A remote control system includes a RF communication chipset that has a transceiver and antenna at a handset/remote and another transceiver and antenna at a base station is operable to maintain a two-way communication connection. The two-way communication connection includes the capability of uploading display data for presentation on a display located at the handset/remote, and also includes the capability of downloading keystroke codes from the handset/remote keyboard. A processor is in communication with the base station, and is operable to control an infrared emitter. Devices are controlled by infrared commands decoded from the downloaded keystrokes and provided to the infrared emitter. Full telephonic capability is supported between the handset/remote and a plain old telephone system.

### FIELD OF INVENTION

The present invention relates to a remote control system, and in particular to a remote control system which incorporates interactive communication through a radio frequency channel.

### BACKGROUND OF THE INVENTION

Entertainment systems, or media centers, have become increasingly popular and appear in one form or another within homes, offices and businesses in some form or another. These systems typically include one or more display devices that are capable of audio, video, or audio/video presentation. Also present in entertainment systems are playback devices that are capable of receiving or reproducing analog, digital, or analog/digital data. The entertainment system can include a television, a radio, a CD player, a tape player (analog or digital), a DVD player, a VCR player, a personal computer, a video monitor, and speakers (front, center, rear, subwoofer). The system can even include a device that is an integrated combination of some or all of the preceding devices.

Each of these devices are typically capable of being controlled remotely by a user via a handheld device, i.e., a remote control. Oftentimes, a manufacturer provides one remote control capable of controlling multiple devices produced by that manufacturer. In an attempt to reduce the number of remote controls necessary to operate the entertainment center, universal remote controls are available which are programmable to control devices from multiple manufacturers.

To further consolidate remote controls, some attempts have been made to integrate a remote control into cordless telephone handsets. One approach has been to integrate a complete infrared (IR) remote control into the same housing as the cordless phone. Wireless phones supporting the IRDA wireless connectivity standard can be programmed to turn on a television, control a VCR or DVD playback device, change the channel, stop, pause, rewind, etc. An IrDA adapter provides a bridge to a USB port of a personal computer and is complaint with a standard Infrared Data Telecom interface. The IrDA interface typically provides for wireless data transfer for data logging, synchronization, file transfer and backup, or printing.

A commercial example of a combination remote-control/phone incorporating these features is the Model 3318 Remote Phone produced by Innovative Intelcom Industries of California. The Remote Phone is a cordless telephone with a multi-device IR remote controller built into the same handset, and is capable of controlling TV, VCR, satellite, cable, DVD, and other home devices.

Another approach to control various entertainment devices in one integrated remote controllers uses radio frequency (RF) transmissions to send control signals from the remote to a base station, which then emits the IR control signals necessary to control the devices. The IntelliControl Home Theater Automation System from Niles Audio Corporation of Miami, Florida is an example of this kind of integrated remote control. The IntelliControl System includes a tabletop remote with a touch screen interface that sends RF signals to a main system unit. The main system unit interprets and decodes the RF signals into the proper infrared signal for the device selected for control, and then provides an infrared command via cables to an infrared flasher mounted in proximity to the infrared detector of the device.

The remote controls known in the art provide control of the entertainment system devices, but only in a unidirectional manner. What is missing from the art is a remote control which implements both cordless telephone features and functions as well as remote control of the various entertainment system devices, and further provides feed-back and interactive display and control of these devices. The present invention can satisfy one or more of these and other needs.

### SUMMARY OF THE INVENTION

The present invention relates to a remote control system. In accordance with one aspect of the invention, the remote control system includes a RF communication chipset that has a transceiver and antenna at a handset/remote and another transceiver and antenna at a base station. The transceivers are operable to maintain a two-way communication connection with the capability of uploading display data for presentation on a display located at the handset/remote, and also further includes the capability of downloading keystroke codes from the handset/remote keyboard. A processor is in communication with the base station, and is configured to provide signals to an infrared emitter. The remote control system also support full telephonic capability between the handset/remote and a plain old telephone system.

These and other aspects, features, steps and advantages can be further appreciated from the accompanying figures and description of certain illustrative embodiments.

### BRIEF DESCRIPTION OF THE DRAWINGS FIGURES

FIG. 1 is a schematic diagram of an embodiment of the present invention;

FIG. 2 is a schematic diagram of one embodiment for the base component depicted in FIG. 1;

FIG. 3 is a schematic diagram of another embodiment for the base component depicted in FIG. 1; and

FIG. 4 is a schematic diagram of one embodiment of the handset/remote depicted in FIG. 1.

### DEFINITION OF TERMS

The terms used in this specification generally have their ordinary meanings in the art, within the context of the invention, and in the specific context where each term is used. Certain terms are discussed below, or elsewhere in the specification, to provide additional guidance to the practitioner in describing the devices and methods of the invention and how to make and use them. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to the preferred embodiments.

“Playback device” and “player” mean an appliance that is capable of receiving, rendering, and optionally transmitting audio, video, or audiovisual data, including digital media.

“Audio,” “video,” “audiovisual data,” “audio/video,” “audiovisual media,” “media content,” and the like, mean any information in any analog or digital format which can be displayed, rendered or perceived in sight and/or sound, with or without any other accompanying information that is “hidden,” i.e., not displayed, rendered or perceived. For example, “audiovisual data” includes both digital and/or analog media. Likewise, “content” also refers to the audiovisual data, with or without additional “hidden” information.

“Digital media,” “digital signal,” or “digital content” means any digital representation of an audio and/or video performance, of any content and in any format, with or without additional non-representational information, e.g., control information, and whether or not the digital media or signal is converted from or to an analog signal. Many digital media formats are known, including for example, MP3, MPEG, JPEG, TIFF, Real Media and Windows Media. Digital media may also be stored in any physical form, such as on a hard drive, in solid state memory, on a CD or DVD, tape, etc. The hard drive and memory can be stand-alone devices connectable to a network or a Personal Computer, or may be connectable or located in the Personal Computer itself.

Digital media (or a digital signal) may be converted to analog media (or an analog signal), e.g., for display, rendering and perception by a user. For example, an audiovisual presentation stored in a digital format may be converted to one or more analog signals for display of images and/or sound on an analog display device, such as a conventional television. Alternatively, a digital signal may be rendered on a digital display without conversion to an analog signal. Digital audio and visual media or signals may be rendered separately or together, with or without analog conversion. For example, digital video or images may be rendered on a digital display, while corresponding digital audio media or data is converted to an analog signal for playback by an analog speaker system. Methods for digital-to-analog conversion are known, as are methods to synchronize the audio and video portions of a signal during its playback.

“Analog media” or an “analog signal” means any analog representation of an audio and/or video performance, whether or not the analog media or signal is converted from or to digital data or a digital signal. Thus, an analog signal may optionally be captured and converted to digital media for storage and/or transmission to other devices for playback. For example, images from a digital camera, or audio from a telephone device, such as an IP telephone, may be converted from analog to digital signals by the camera or telephone, or by another device or process e.g., residing on a network.

### Detailed Description of the Illustrative Embodiments

By way of overview and introduction, presented and described are embodiments of a infrared (IR) remote control system which incorporates cordless phone capabilities to achieve interactive control of entertainment, or media, system devices. The remote control system utilizes standard serial radio frequency (RF) communication chipsets, Digital Enhanced Cordless Telecommunication (DECT) chipsets, or any similar chipset to achieve RF communications between a cordless remote handset and a base station. The cordless remote handset has full telephony capabilities along with remote control capabilities of entertainment system devices including playback, record, source selection, output control, pause, stop, rewind, scan, etc.

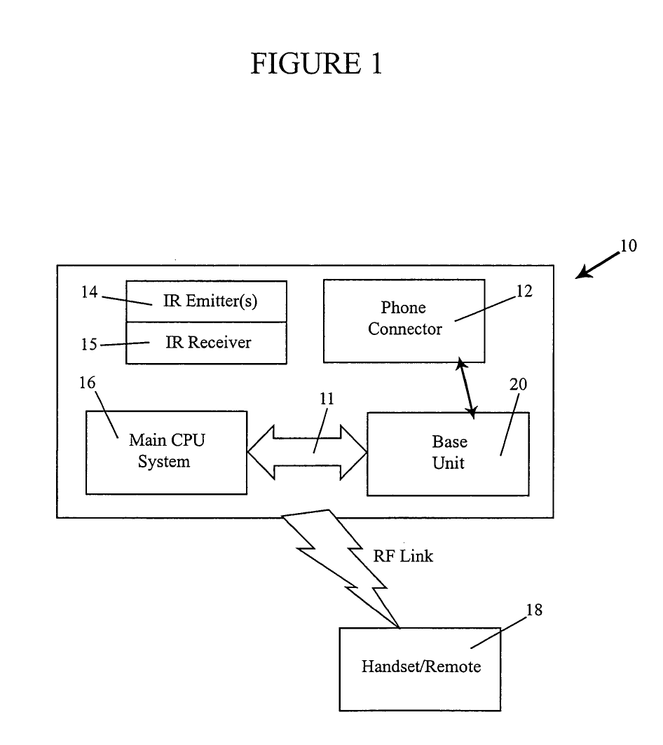

FIG. 1 is a schematic diagram of an embodiment of the remote control system 10. The remote control system includes a base station 20 that is connected over a data bus 11 to a main central processing unit (CPU) 16. Connected to the base station 20 is a phone connector 12 suitable for interface to a plain old telephone system (POTS). Also connected to the base station 20 are IR emitters 14 and an IR receiver 15 (connections not shown). An RF link establishes communication with a handset/remote 18.

A DECT compliant phone is a digital wireless phone that uses time domain multiple access (commonly referred to as TDMA) to transmit radio signals to phones. A RF module is located in both the base station 20 and the handset/remote 18. Each RF module acts as a transceiver (i.e., both transmits and receives signals) to maintain the RF link between the base station 20 and the handset/remote 18.

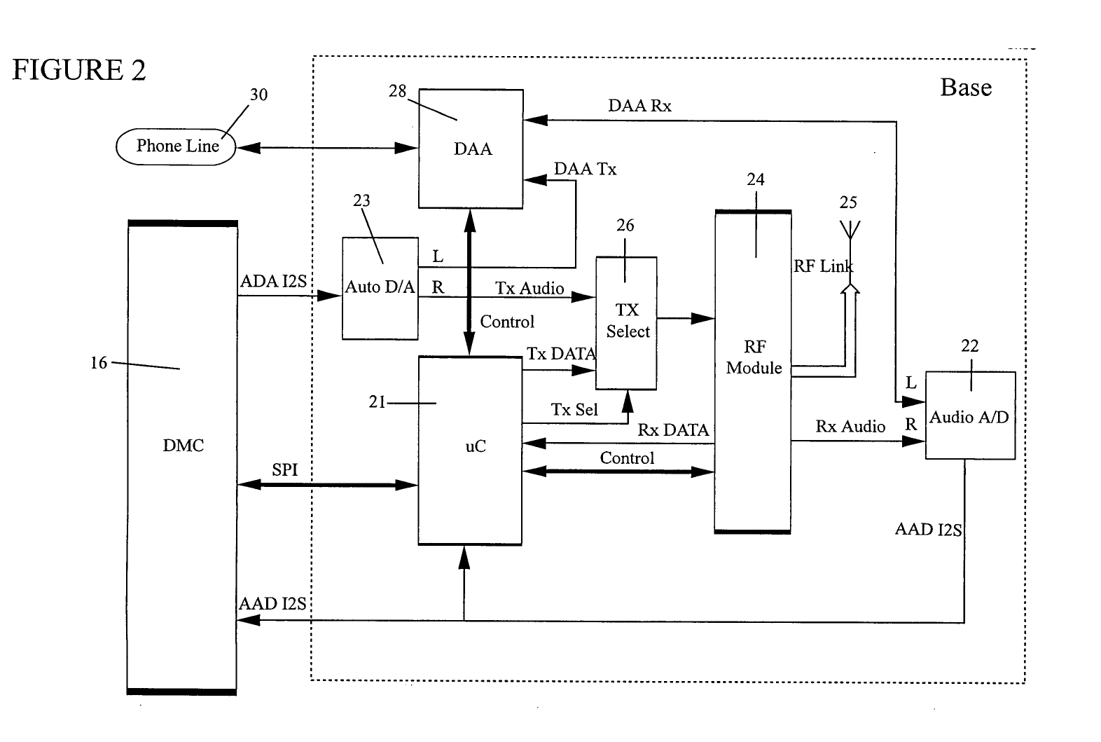

FIG. 2 is a schematic diagram of one embodiment for the base station 20. In this embodiment the CPU 16 is external to the base station 20. Within the base station is microcontroller 21, which interacts with the CPU to perform local logic control of the base station 20. As is understood by a person of skill in the art, the microcontroller 21 can itself be a CPU. Additionally, not shown, but required and present are memory, both static and dynamic. Stored within the memory are operating instructions that are executable by either the CPU 16 or the microcontroller 21 so as to control the various components and functions of the remote control system 10.

The external CPU 16 can be located within a digital media control center, which is a network connected device that interfaces with multiple media playback devices and digital storage mediums. The media center is in communication with the playback devices (audio, visual, or audio/visual) over the network. Also connected to this network can be a personal computer, a modem, and Internet access. The media center contains a user interface that accepts commands from a user. The media center can be controlled remotely through signals provided by the base station which are received from keystrokes on the handset/remote 18.

Within the base station are an audio analog-to-digital (A/D) converter 22 and an audio digital-to-analog (D/A) converter 23. The A/D converter 22 receives analog content data, and converts the analog content to digital signal for processing by the remote control system 10. The converted digital data can be sent to the CPU 16 for storage in a network connected device, such as a disk drive or a CD/DVD burner. The analog content itself can be provided by the Data Access Arrangement (DAA) component 28, or a received analog audio signal downloaded from the RF link. The DAA component 28 is a device which implements a standard for connecting to phone lines, as is known in the art.

An RF module 24, an antenna 25, and a transmit select switch 26 form the RF portion within the base station 20. The RF module 24 is a transceiver and includes both receiver front end components and transmitter output amplifiers. The antenna broadcasts the signal to the handset/remote 18. The transmit select switch 26 is controlled by the microcontroller 21, and is used to select what input is provided to the RF module 24 for transmission to the handset/remote. For instance, audio music can be sent to the handset/remote 18 by sending mono track digital music to the D/A converter 23. Alternatively, display data can be sent to the handset/remote for display on the handset display. The RF communication chipset sends data for display on the handset/remote and receives keystroke data back from the handset/remote.

The DECT compatible chipset allows for low bandwidth data transmission at the same time as an on-going voice transmission. This allows for display and control data to be sent to the handset at same time as an on-going conversation. When there is no on-going conversation, the display and control data can be sent at a higher data rate, which encompasses the bandwidth previously occupied by the on-going voice transmission.

In another embodiment the RF communication chipset can be a dual voice/data or data only protocol. In the former instance of dual voice/data protocol, the voice and data can be encoded together and then sent via the RF chipset, or high speed switching between voice and data functions are performed by control through the microcontroller 21 or CPU 16.

In one embodiment, an on-going phone conversation can be recorded in memory through the microcontroller 21 and CPU 16. Although a phone conversation is a two-way communication, each portion is monophonic and present on one channel; the microphone is one channel and the earpiece signal occupies another channel. Phone conversations are stored as data from the A/D converter 22 into memory. The recorded phone conversation is then available for playback on any playback device interconnected to the system, or on the handset/remote 18, after proper selection of the playback device by the user. The base station can control the phone conversation by signaling the DAA 28 to go off-hook and simulate touch tones via the DAA to the phone line.

In one embodiment, music can be played by sending, under the control of the CPU 16, a monaural signal stored as digital content to the D/A converter 23. This monaural signal can be played on the handset (for listening) or on the phone line (as music on hold). Additionally, the microcontroller 21 can control the phone conversation by signaling the DAA component 28 to go off-hook, and even control the phone line by simulating touch tone signals over the phone line through the DAA.

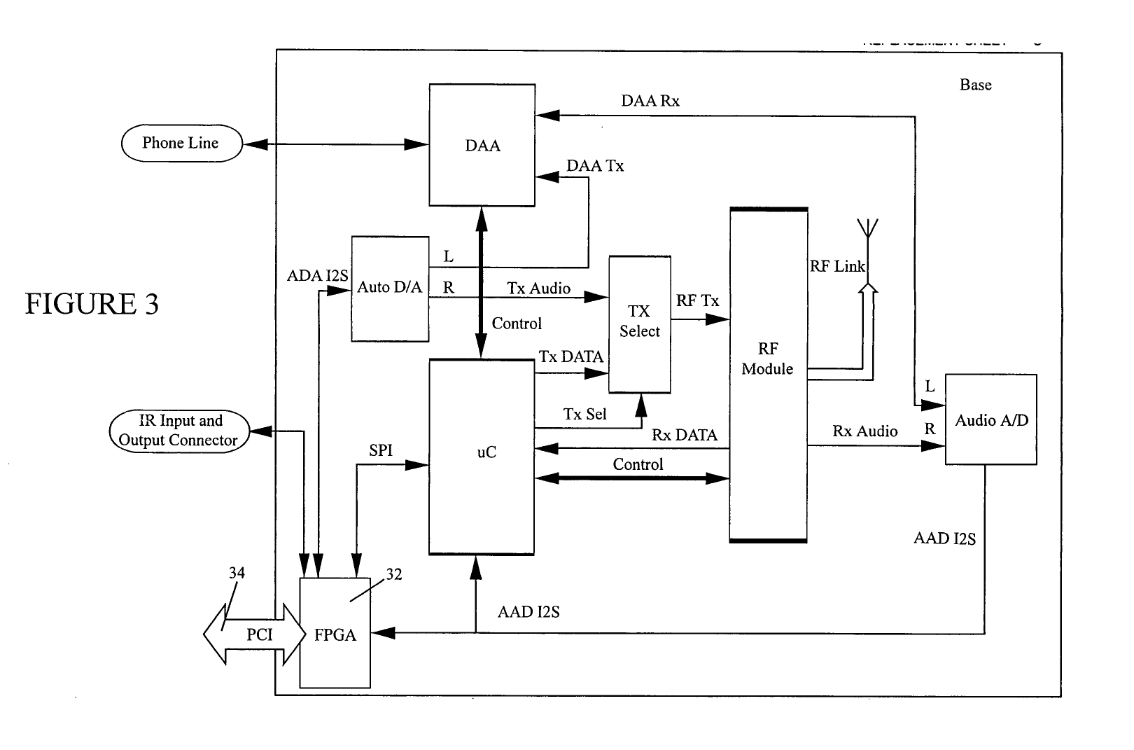

FIG. 3 is a schematic diagram of another embodiment of the base station 20. In this embodiment the base station 20 contains a Filed Programmable Gate Array (FPGA) 32 and a Peripheral Component Interconnect (PCI) bus 34. The PCI bus is an interconnection system between a microprocessor and attached devices. This embodiment of base station 20 contains similar components and operates in a similar manner as does the previously described embodiment.

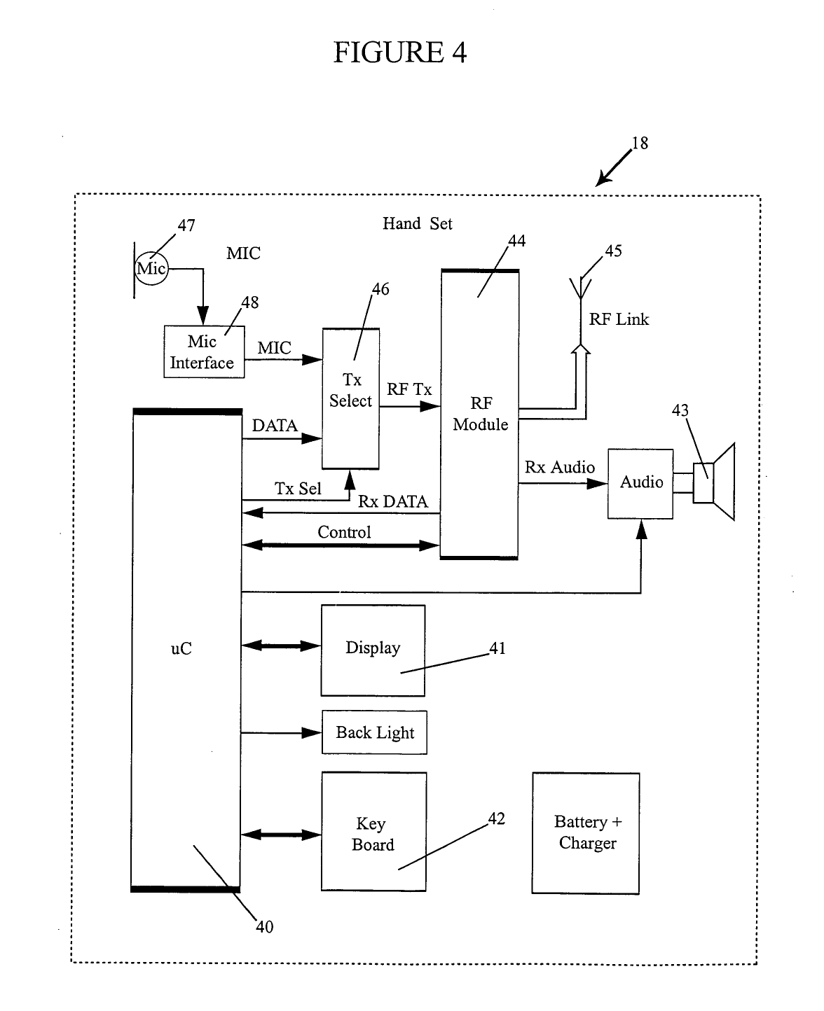

FIG. 4 is a schematic diagram of one embodiment of the handset/remote 18. The handset/remote 18 is capable of operating as a cordless telephone and a remote control. Included in the handset/remote 18 is an RF portion containing an RF module 44, an antenna 45, and a transmit select switch 46, which are counter part components to the RF portion within the base station 20 and operate in the same way.

The handset/remote 18 also includes a display 41 and a keyboard 42. The display 41 is typically a LCD display screen and can have black and white or color capability. In one embodiment the display 41 can incorporate a touch screen feature. Other forms of displays that have low power consumption, small packaging requirements, and low weight are within the contemplation of the present invention. The keyboard 42 is an alpha-numeric keyboard arranged to accommodate telephone dialing. Additionally, the keyboard contains menu keys and selection keys. In one embodiment the keyboard contains a mouse touch pad and/or a scroll wheel with a button.

The functions on the keyboard are programmable based on user selection from the menu. In one embodiment the keyboard function defaults to the phone keys, and a user can initiate or receive a phone call from the handset/remote 18. By activation of the menu button, a menu is displayed on the display 41. A user can scroll through the menu by using the selection keys (up, down, left, or right) and make a selection. When the mouse touchpad or scroll wheel are present, the same selection can be performed by using these features.

Menu selection determines the function of to which the keyboard keys are programmed. A user can select control of the various devices through the menu, and the keys would be appropriately programmed to enable selection of functions for the particular device selected by the user. For instance, selecting control of a playback device may require keys programmed for stop, pause, play, rewind and fast forward. Should the user select a radio or television, the key functions would be programmed, perhaps, for tuner selection, bass and treble adjustment, speaker balance and fade, picture brightness and color contrast, etc. Feedback upon key activation is provided to the user through menu selection highlight text, audible key clicks, and other such positive indicators. The menu displays are interactively linked to the keystrokes on the keyboard. Additional menu displays can be made available by drilling down through the menus presented on the display.

In an embodiment where the user can, through menu selection, control more than one device, the remote control system is a universal remote control by virtue of the embodiment's adaptability to control a variety of devices and device types.

User keystrokes on the handset/remote 18 are transmitted to the base station 20 via the RF link. If the keystrokes are telephonic dial commands, the DAA 28 places the phone line off-hook and a phone call is initiated. If the keystrokes are commands to an entertainment device, the commands are decoded into the proper IR code for the particular device and forwarded to the IR emitter(s) 14 associated with that device.

Digital content data stored in memory can be sent via the RF link to the handset/remote 18 for presentation on the display 41. Through the menu and selection buttons on the handset/remote the user can select a source for the digital content, and then control the playback of that digital content through a playback device appropriate for the particular format of digital content. Analog media content is converted to digital content prior to being made available for transmission to the base station and subsequent forwarding to the handset/remote via the RF link.

Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one described embodiment to another are also fully intended and contemplated. The invention is defined solely with regard to the claims appended hereto, and equivalents of the recitations therein.

I claim:

1. A remote control system comprising:
a RF communication chipset including a first transceiver and first antenna disposed at a handset/remote and a second transceiver and second antenna disposed at a base station;
the handset/remote and the base station operable to maintain a two-way communication connection;
a processor, in communication with the base station, configured to control an infrared emitter.

2. The remote control system of claim 1, further comprising:
a display and keyboard disposed at the handset/remote; and
the two-way communication connection including the capability of transmitting display data to the handset/remote display.

3. The remote control system of claim 2, wherein keystrokes transmitted from the handset/remote are decoded by the processor and forwarded to the infrared emitter to generate infrared control signals.

4. The remote control system of claim 2, further comprising a data access arrangement connected to the RF communication chipset;
wherein keystrokes transmitted from the handset/remote are control signals that cause the data access arrangement component to control a telephone system.

5. The remote control system of claim 3, wherein the display data contains menu screens that are interactively linked to keyboard keystrokes.

6. The remote control system of claim 1, wherein telephone conversations are stored in memory as digital data, and wherein the stored conversations are available for playback.

7. The remote control system of claim 1, further comprising:
at least one digital storage device containing digital content, and connected to the processor; and
a digital access arrangement to connect to a telephone system;
wherein the processor is operable to provide the digital content to the digital access arrangement, and
wherein the digital content is played on the telephone system as a music-on-hold feature.

8. The remote control system of claim 1, wherein the RF communication chipset is a digital enhanced cordless telecommunication chipset.

9. The remote control system of claim 1, wherein the RF communication chipset is a dual data and voice chipset

10. A handset/remote comprising:
a RF communication chipset including a first transceiver and first antenna disposed at the handset/remote;
a display and keyboard disposed at the handset/remote;
the RF communication chipset capable of supporting two-way communication including the capability of uploading display data for presentation on the display.

11. The handset/remote of claim 10, wherein the RF communication chipset includes the capability of downloading keystroke codes from the keyboard.

12. The handset/remote of claim 10, wherein the display data contains menu screens that are interactively linked to keystrokes on the keyboard.

13. A method of remote control comprising the steps of
providing a base station and a handset/remote capable of maintaining a two-way communication connection;
uploading display data for presentation on a display at the handset/remote; and
downloading keystroke codes from a keyboard located at the handset/remote.

14. The method of claim 13, further comprising the steps of:
downloading telephonic communication signals from the handset/remote;
forwarding the telephonic communication signals to a digital access arrangement; and
recording the telephonic communication signals in a data storage for later playback.

15. The method of claim 13, wherein the uploaded display data contains menu screens that are interactively linked to the keyboard keystrokes.
